(19) United States
(12) Patent Application Publication
(10) Pub. No.: US 2025/0104892 A1
(43) Pub. Date: Mar. 27, 2025

(54) NONLINEAR-RESISTANCE RESIN MATERIAL, NONLINEAR RESISTOR, OVERVOLTAGE PROTECTOR, AND MANUFACTURING METHOD OF NONLINEAR-RESISTANCE RESIN MATERIAL

(71) Applicant: Mitsubishi Electric Corporation, Tokyo (JP)

(72) Inventor: Katsuya JINNO, Tokyo (JP)

(73) Assignee: Mitsubishi Electric Corporation, Tokyo (JP)

(21) Appl. No.: 18/730,305

(22) PCT Filed: Dec. 21, 2022
(86) PCT No.: PCT/JP2022/047193

§ 371 Date: Jul. 19, 2024

(30) Foreign Application Priority Data
Jan. 24, 2022 (WO) PCT/JP2022/002377

(51) Int. Cl. H01C 7/12; H01C 7/10; H01C 7/112; H01C 7/118; H01C 17/065

(52) U.S. Cl. CPC H01C 7/12; H01C 7/1006; H01C 7/112; H01C 7/118; H01C 17/06586

(57) ABSTRACT

A nonlinear-resistance resin material includes: a plurality of first particles having nonlinear resistance characteristics that exhibit insulation properties when a voltage lower than a threshold value is applied and exhibit conductivity when a voltage equal to or higher than the threshold value is applied; a first resin phase containing second particles that are semiconducting or conducting, and covering at least partially surfaces of some or all of the plurality of first particles; and a second resin phase having insulation properties, and filling voids where none of the first particles and the first resin phase exists. The first particles adjacent to each other are bound and electrically connected to each other via the first resin phase.

### FIELD

The present disclosure relates to a nonlinear-resistance resin material having nonlinear resistance characteristics, a nonlinear resistor using the nonlinear-resistance resin material, an overvoltage protector including the nonlinear resistor, and a manufacturing method of the nonlinear-resistance resin material.

### BACKGROUND

Conventionally, a device having a high electric field portion is designed such that an electric field falls below an allowable value. As the electric field gets smaller than the allowable value, insulation distance can be shortened. Thus, downsizing of the device can be promoted. Therefore, relaxing the electric field leads to downsizing of the device.

Conventionally, a technique in which a nonlinear-resistance resin material is disposed in a high electric field portion of a device is known as a technique for relaxing an electric field. The nonlinear-resistance resin material has nonlinear resistance characteristics such that the nonlinear-resistance resin material exhibits insulation properties when a voltage lower than a threshold value is applied and that the nonlinear-resistance resin material exhibits conductivity when a voltage equal to or higher than the threshold value is applied. For example, Patent Literature 1 discloses, as such a nonlinear-resistance resin material, an electric field relaxation agent in which particles having nonlinear resistance characteristics are blended with semiconducting whiskers and a single type of resin.

### CITATION LIST

### Patent Literature

Patent Literature 1: Japanese Patent Application Laid-open No. 2015-101714

### SUMMARY OF INVENTION

### Problem to be Solved by the Invention

In the electric field relaxation agent disclosed in Patent Literature 1, semiconducting whiskers are dispersed in the entire resin. Therefore, it is necessary to add a large number of semiconducting whiskers so as to obtain sufficient conductivity. However, as the number of added semiconducting whiskers increases, the semiconducting whiskers are more likely to be joined together. Thus, electricity is more likely to be conducted in a thickness direction. As a result, there is a possibility that a resistance value may fall below a resistance value of designed nonlinear resistance characteristics and thus, the function of the electric field relaxation agent as an insulator may decrease under conditions where the electric field relaxation agent should function as an insulator. Note that the thickness direction refers to a Z direction of X, Y, Z coordinates, and refers to, for example, a pressing direction in a case where a nonlinear-resistance resin material is pressed, and a direction of a film thickness of a nonlinear-resistance resin material in a case where the nonlinear-resistance resin material is used as a coating material.

The present disclosure has been made in view of the above, and an object of the present disclosure is to obtain a nonlinear-resistance resin material capable of preventing a decrease in the function of the nonlinear-resistance resin material as an insulator under conditions where the nonlinear-resistance resin material should function as an insulator.

### Means to Solve the Problem

To solve the above problems and achieve the object, a nonlinear-resistance resin material according to the present disclosure includes: a plurality of first particles having nonlinear resistance characteristics exhibiting insulation properties when a voltage lower than a threshold value is applied, and exhibiting conductivity when a voltage equal to or higher than the threshold value is applied; a first resin phase containing second particles that are semiconducting or conducting and covering at least partially surfaces of some or all of the plurality of first particles; and a second resin phase having insulation properties and filling voids where none of the first particles and the first resin phase exists. The first particles adjacent to each other are bound and electrically connected to each other via the first resin phase.

### Effects of the Invention

The present disclosure has the effect of preventing a decrease in the function of a nonlinear-resistance resin material as an insulator under conditions where the nonlinear-resistance resin material should function as an insulator.

### BRIEF DESCRIPTION OF DRAWINGS

FIG. 1 is a diagram schematically illustrating a nonlinear-resistance resin material according to a first embodiment.

FIG. 2 is an enlarged view of a portion A illustrated in FIG. 1.

FIG. 3 is a diagram schematically illustrating a first particle and a first resin phase in the first embodiment.

FIG. 4 is an enlarged view of a portion B illustrated in FIG. 3.

FIG. 5 is a diagram illustrating: current-voltage characteristics of first particles of the nonlinear-resistance resin material according to the first embodiment; current-voltage characteristics of a material in a state close to an insulator; and current-voltage characteristics of a material in a state close to a conductor.

FIG. 6 is a diagram schematically illustrating a nonlinear-resistance resin material according to a first modification of the first embodiment.

FIG. 7 is an enlarged view of a portion C illustrated in FIG. 6.

FIG. 8 is a diagram schematically illustrating a nonlinear-resistance resin material according to a second modification of the first embodiment.

FIG. 9 is a diagram illustrating energizing paths of the nonlinear-resistance resin material according to the second modification of the first embodiment.

FIG. 10 is a diagram schematically illustrating a nonlinear-resistance resin material according to a third modification of the first embodiment.

FIG. 11 is a diagram schematically illustrating an example of connection between an overvoltage protector according to a second embodiment and a to-be-protected device, and is a diagram illustrating a case where a voltage less than a threshold value is applied.

FIG. 12 is a diagram schematically illustrating an example of connection between the overvoltage protector according to the second embodiment and the to-be-protected device, and is a diagram illustrating a case where a voltage equal to or higher than the threshold value is applied.

FIG. 13 is a diagram schematically illustrating a nonlinear resistor of the overvoltage protector according to the second embodiment, and is a diagram illustrating the nonlinear resistor using the nonlinear-resistance resin material according to the first embodiment.

FIG. 14 is a diagram schematically illustrating a nonlinear resistor of the overvoltage protector according to the second embodiment, and is a diagram illustrating the nonlinear resistor using the nonlinear-resistance resin material according to the first modification of the first embodiment.

FIG. 15 is a diagram schematically illustrating a nonlinear-resistance resin material according to a third embodiment.

FIG. 16 is a diagram illustrating particle size distributions of first particles of the nonlinear-resistance resin material according to the third embodiment.

FIG. 17 is a diagram illustrating the relationship between the mixing ratio and filling factor of the first particles in the nonlinear-resistance resin material according to the third embodiment.

FIG. 18 is a diagram illustrating energizing paths of the nonlinear-resistance resin material according to the third embodiment.

FIG. 19 is a diagram illustrating current-voltage characteristics of the first particles of the nonlinear-resistance resin material according to the third embodiment and current-voltage characteristics of the first particles of the nonlinear-resistance resin material according to the first embodiment.

FIG. 20 is a diagram schematically illustrating a nonlinear-resistance resin material according to a modification of the third embodiment.

### DESCRIPTION OF EMBODIMENTS

Hereinafter, nonlinear-resistance resin materials, a nonlinear resistor, an overvoltage protector, and a manufacturing method of a nonlinear-resistance resin material according to embodiments will be described in detail with reference to the drawings.

### First Embodiment

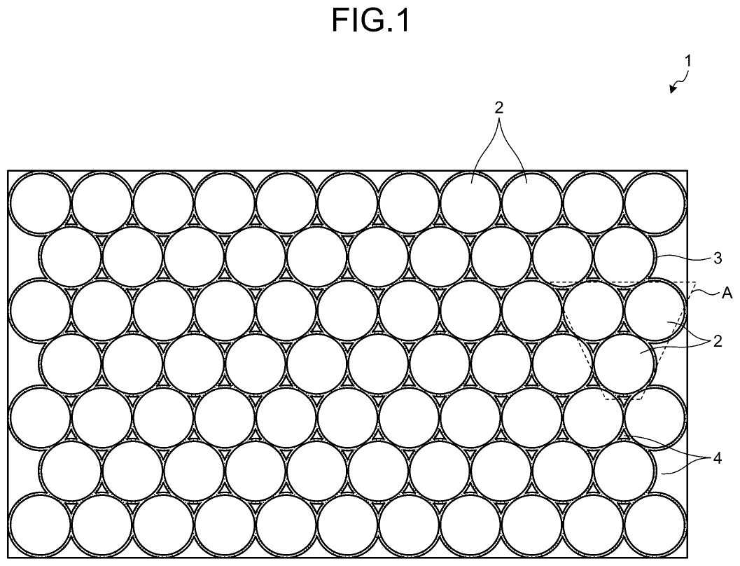

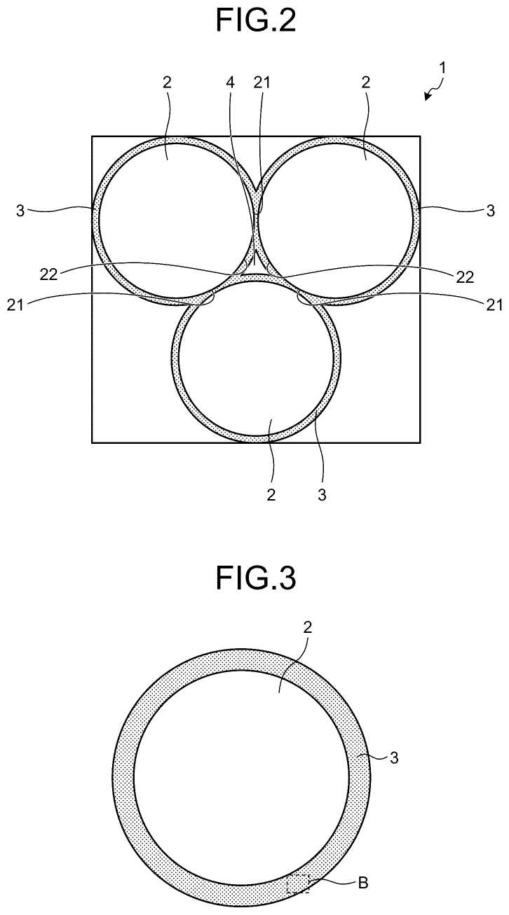

FIG. 1 is a diagram schematically illustrating a nonlinear-resistance resin material 1 according to a first embodiment. FIG. 2 is an enlarged view of a portion A illustrated in FIG. 1. As illustrated in FIG. 1, the nonlinear-resistance resin material 1 includes: a plurality of first particles 2; and a first resin phase 3 that covers surfaces of some or all of the plurality of first particles 2. In the present embodiment, the first resin phase 3 covers surfaces of all the plurality of first particles 2. The first particles 2 adjacent to each other are bound and electrically connected to each other via the first resin phase 3. The nonlinear-resistance resin material 1 includes voids 4 where none of the first particles 2 and the first resin phase 3 exists. The voids 4 are formed between outer edges of the nonlinear-resistance resin material 1 and the first particles 2. As illustrated in FIG. 2, the void 4 is also formed in a portion surrounded by three adjacent first particles 2. Note that although FIG. 1 illustrates a state in which the first particles 2 with the same diameter are regularly arranged, the first particles 2 with various diameters are densely bound when the first particles 2 having a plurality of particle size distributions are used.

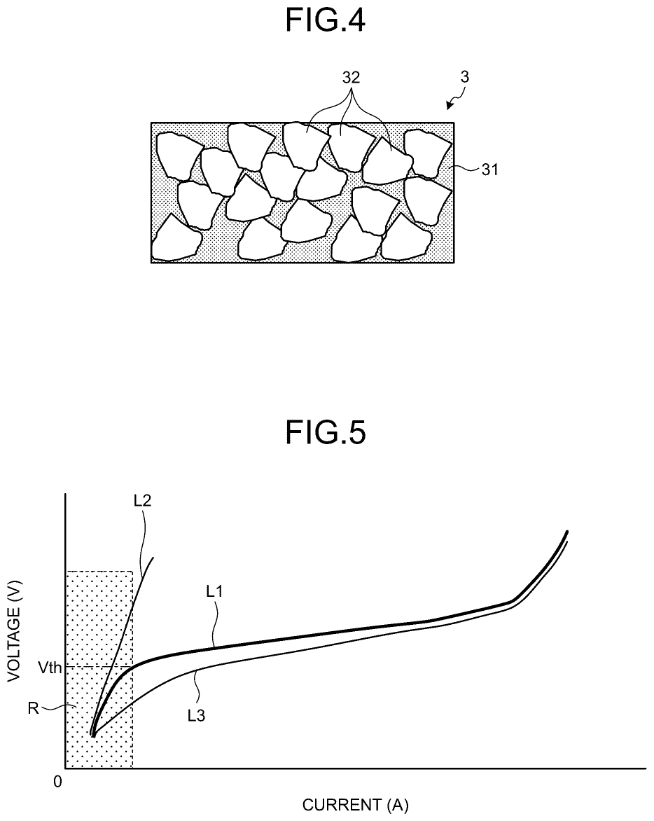

FIG. 3 is a diagram schematically illustrating the first particle 2 and the first resin phase 3 in the first embodiment. FIG. 4 is an enlarged view of a portion B illustrated in FIG. 3. The first particle 2 illustrated in FIG. 3 has nonlinear resistance characteristics such that the first particle 2 exhibits insulation properties when a voltage lower than a threshold value is applied and that the first particle 2 exhibits conductivity when a voltage equal to or higher than the threshold value is applied. That is, the first particles 2 have the property of reversibly changing from an insulator to a conductor, and vice versa, at a threshold voltage Vₜₕ. Therefore, while general materials follow Ohm's law, the first particles 2 do not follow Ohm's law. Thus, the first particles 2 are commonly called “varistors”. In particular, particulate varistors such as the first particles 2 are called “microvaristors”.

FIG. 5 is a diagram illustrating: current-voltage characteristics of the first particles 2 of the nonlinear-resistance resin material 1 according to the first embodiment; current-voltage characteristics of a material in a state close to an insulator; and current-voltage characteristics of a material in a state close to a conductor. In FIG. 5, the horizontal axis represents current (A), and the vertical axis represents voltage (V). A line L1 illustrated in FIG. 5 indicates the current-voltage characteristics of the first particles 2. A line L2 illustrated in FIG. 5 indicates the current-voltage characteristics of the material in a state close to an insulator. A line L3 illustrated in FIG. 5 indicates the current-voltage characteristics of the material in a state close to a conductor.

As illustrated in FIG. 5, it can be seen that the electric resistance of the first particles 2 changes at the threshold voltage Vₜₕ, to cause current to rapidly flow. The threshold voltage Vₜₕ is not within a small current region R shaded by dots in FIG. 5. That is, when an applied voltage is smaller than the threshold voltage Vₜₕ, the first particles 2 exhibit insulation properties. Meanwhile, when the applied voltage is larger than the threshold voltage Vₜₕ, the first particles 2 rapidly decrease in electric resistance, and exhibit conductivity. It can be seen that the current-voltage characteristics of the first particles 2 are different from the current-voltage characteristics of the material in a state close to an insulator and the material in a state close to a conductor that are materials following Ohm's law.

In the present disclosure, a nonlinear resistance index, which is obtained by quantification of nonlinear resistance characteristics, represents the degree of rapid change in electric resistance at the threshold voltage Vₜₕ. The nonlinear resistance index is obtained from the slope of two points on a graph of current-voltage characteristics, and is generally expressed by formula (1) below.

$$Nonlinear restistance index = ( log {I}_{2} - log {I}_{1} ) / ( log {V}_{2} - log {V}_{1} ) \qquad ( 1 )$$

The better the nonlinear resistance characteristics, the larger the nonlinear resistance index. It can be said that the nonlinear resistance characteristics are good and the nonlinear resistance index is large in a case where current starts to rapidly flow as the applied voltage exceed the threshold voltage Vₜₕ as in the case of the first particles 2 indicated by the line L1 in FIG. 5. Meanwhile, it can be said that the nonlinear resistance characteristics are poor and the nonlinear resistance index is small in the case of the material in a state close to an insulator with small nonlinear resistance characteristics as indicated by the line L2 in FIG. 5. In addition, it can be said that no nonlinear resistance characteristics are exhibited and the nonlinear resistance index is small in the case of the material in a state close to a conductor with no nonlinear resistance characteristics as indicated by the line L3 in FIG. 5.

Several types of accessory component are added in minute quantities to a main component, and a mixture thereof is fired. A material thus obtained is used as the first particles 2 illustrated in FIG. 3. Performance such as the magnitude of the threshold voltage Vₜₕ, volume resistance in the case of an insulator, and nonlinear resistance characteristics can be controlled according to the composition of the first particles 2. For example, zinc oxide or silicon carbide is used as the main component of the first particles 2. From the viewpoint of ensuring sufficient nonlinear resistance characteristics of the first particles 2, the first particles 2 preferably contains 80 wt % or more zinc oxide or silicon carbide. Zinc oxide having higher nonlinear resistance characteristics than silicon carbide is preferably used as the main component of the first particles 2. Examples of the accessory component of the first particles 2 include bismuth oxide, antimony oxide, chromium oxide, nickel oxide, manganese oxide, cobalt oxide, and silicon oxide. The composition of the first particles 2 is adjusted according to uses.

Here, a manufacturing method of the first particles 2 will be described. The following description is based on the assumption that the main component of the first particles 2 is zinc oxide powder. First, 95.8 mol % of zinc oxide powder is weighed for use as a main component. Next, 0.5 mol % of bismuth oxide, 1.2 mol % of antimony oxide, 0.5 mol % of chromium oxide, 0.5 mol % of nickel oxide, 0.5 mol % of manganese oxide, 0.5 mol % of cobalt oxide, and 0.5 mol % of silicon oxide are weighed for use as accessory components, and the weighed accessory components are added to the zinc oxide powder. These raw materials are pulverized and mixed by use of water as a medium. At this time, it is desirable to pulverize and mix the raw materials such that the raw materials are uniform and equal in average particle diameter. Subsequently, the pulverized and mixed raw materials are sprayed into the atmosphere at a high temperature of 100° C. or higher to spray-dry the raw materials. As a result, spherical granules are obtained in which raw materials such as zinc oxide powder, bismuth oxide, antimony oxide, chromium oxide, nickel oxide, manganese oxide, cobalt oxide, and silicon oxide are uniformly aggregated. Then, the granules are put in a sagger and fired at a temperature of 1200° C. Since the fired granules are aggregated, pressure is applied to perform crushing so as to break the aggregation.

As a result of performing the above steps, the first particles 2 having nonlinear resistance characteristics are obtained.

The first particle 2 is a spherical aggregate of primary particles of zinc oxide or silicon carbide. Although minute irregularities are actually observed, the first particle 2 is substantially spherical. The diameters of the first particles 2 can be adjusted according to solid content concentration in the case of pulverizing and mixing materials by use of water as a medium, spray pressure, and the like. Thus, the diameters of the first particles 2 may be appropriately changed according to the uses of the nonlinear-resistance resin material 1. The average diameter of the primary particles contained in the main component of the first particles 2 is preferably less than 20 μm from the viewpoint of the magnitude of the threshold voltage Vₜₕ and adhesion to the first resin phase 3.

Zinc oxide or silicon carbide having the shape of a partially crushed sphere may be used as the first particles 2. The term “partially crushed” refers to a state in which zinc oxide or silicon carbide is not pulverized to a primary particle level and thus, aggregation of primary particles of zinc oxide or silicon carbide remains. In other words, each first particle 2 may be an aggregate of two or more primary particles. When such first particles 2 are used, nonlinear resistance characteristics are poorer than in the case of using the spherical first particles 2, but the degree of freedom of pressure increases during a crushing process at the time of production. Thus, productivity of the first particles 2 can be improved. In addition, zinc oxide or silicon carbide in which aggregation has not been completely broken may be used as the first particles 2. Even when such first particles 2 are used, the degree of freedom of pressure increases during a crushing process at the time of production. Thus, productivity of the first particles 2 can be improved. However, when partially crushed zinc oxide or silicon carbide, or zinc oxide or silicon carbide in which aggregation has not been completely broken is used, viscosity increases at the time of mixing with resin. Thus, zinc oxide or silicon carbide to be used as the first particles 2 may be appropriately selected according to the uses of the nonlinear-resistance resin material 1.

The first resin phase 3 illustrated in FIG. 3 covers at least a part of a surface of each first particle 2, and has semiconductivity or conductivity. As illustrated in FIG. 4, the first resin phase 3 contains a first matrix resin 31 and a plurality of second particles 32. The second particles 32 have conductivity or semiconductivity.

A solvent-insoluble resin may be used as the first matrix resin 31. Meanwhile, a solvent-soluble resin such as a polyvinyl alcohol resin, polyvinyl butyral, or polylactic acid is preferably used as the first matrix resin 31. For example, water can be used as a solvent for polyvinyl alcohol resin, ethanol can be used as a solvent for polyvinyl butyral, and chloroform can be used as a solvent for polylactic acid. From the viewpoint of the safety and workability of solvent, it is preferable to use a polyvinyl alcohol resin as the first matrix resin 31. In the present embodiment, a polyvinyl alcohol resin has been used as the first matrix resin 31.

For example, metal powder, carbon powder, or conductive ceramic powder is used as the second particles 32. From the viewpoint of ease of mixing, it is preferable to use carbon powder as the second particles 32. In the present embodiment, carbon powder has been used as the second particles 32.

The first resin phase 3 may cover the entire surface of the first particle 2 as illustrated in FIG. 3, however does not necessarily need to cover the entire surface of the first particle 2, but the first resin phase 3 may cover at least a part of the surface of the first particle 2. The first resin phase 3 preferably covers 50% or more of the surface of each first particle 2, and more preferably covers 70% or more of the surface of each first particle 2, from the viewpoint of binding adjacent first particles 2 to each other in a subsequent step. The average diameter of the second particles 32 is preferably 1/10 or less of the average diameter of the first particles 2. With such a magnitude relationship, the surface of the first particle 2 is easily covered with the second particles 32.

As illustrated in FIG. 2, each of the first particles 2 includes: a contact portion 21 being in contact with an adjacent first particle 2 via the first resin phase 3; and a noncontact portion 22 being in no contact with adjacent first particle 2. The contact portion 21 is a portion electrically connected to the adjacent first particle 2 via the first resin phase 3. In the present specification, the term “electrically connected” refers to a state in which adjacent first particles 2 are electrically continuous with each other via the first resin phase 3. The contact portions 21 of the adjacent first particles 2 are bound to each other via the first resin phase 3. In the present specification, the term “binding” refers to connecting the adjacent first particles 2 via the first resin phase 3 by curing the first resin phase 3 in close contact with each of the adjacent first particles 2. There is a case where the first resin phase 3 enters minute irregularities of the first particle 2 and adheres to the first particle 2 by physical binding such as the anchor effect. There is also a case where the first resin phase 3 adheres to the first particle 2 by chemical bonding such as a hydrogen bond due to the influence of moisture resulting from moisture absorption. The first resin phase 3 in a thin state exists between the contact portions 21 of the adjacent first particles 2.

When the volume percent of the first particles 2 in the nonlinear-resistance resin material 1 is small, the first particles 2 are not easily bound to each other. Therefore, from the viewpoint of ease of binding between the first particles 2 and closest packing, the volume percent of the first particles 2 in the nonlinear-resistance resin material 1 is preferably 25 vol % or more and 74 vol % or less. When the volume percent of the second particles 32 in the first resin phase 3 is less than 1 vol %, there is a possibility that adhesion between the first particles 2 may become insufficient due to shortage of conductive components, causing the first resin phase 3 to function substantially as an insulator. Meanwhile, when the volume percent of the second particles 32 in the first resin phase 3 exceeds 40 vol %, there is a possibility that there may be excessive conductive components, causing the first resin phase 3 to near a conductor. Therefore, the volume percent of the second particles 32 in the first resin phase 3 is preferably 1 vol % or more and 40 vol % or less. In addition, the volume percent of the second particles 32 in the nonlinear-resistance resin material 1 is preferably 0.2 vol % or more and 2 vol % or less. The volume of the voids 4 in the nonlinear-resistance resin material 1 is preferably larger than the volume of the first resin phase 3 in the nonlinear-resistance resin material 1.

Next, a manufacturing method of the nonlinear-resistance resin material 1 according to the present embodiment will be described with reference to FIGS. 1 to 4. The manufacturing method of the nonlinear-resistance resin material 1 includes a mixing step, a pressure forming step, and a curing step. Note that these steps are merely examples, and are not intended to limit the manufacturing method of the nonlinear-resistance resin material 1.

The mixing step includes: a step of mixing a plurality of the first particles 2, having nonlinear resistance characteristics such that the first particles 2 exhibit insulation properties when a voltage lower than a threshold value is applied and exhibit conductivity when a voltage equal to or higher than the threshold value is applied, with the first resin phase 3 being semiconducting or conducting; and a step of covering at least partially surfaces of some or all of the plurality of first particles 2 with the first resin phase 3. In the mixing step, first, the first particles 2 illustrated in FIG. 3, polyvinyl alcohol resin serving as the first matrix resin 31 illustrated in FIG. 4, and carbon powder serving as the second particles 32 are weighed and then mixed. In the present embodiment, “GL-05” manufactured by Mitsubishi Chemical Corporation has been used as the polyvinyl alcohol resin. In the present embodiment, “CCE03PB” manufactured by Kojundo Chemical Laboratory Co., Ltd. has been used as the carbon powder. The mixing method is not particularly limited, and may be appropriately selected from among known mixing methods. In the present embodiment, the first particles 2, the first matrix resin 31 in a liquid state (5 wt % aqueous solution), and the second particles 32 have been uniformly mixed by use of a machine. It is desirable to control pressure at the time of mixing so that the first particles 2 are not crushed. As a result of performing the mixing step, the first particles 2 covered with the first resin phase 3 illustrated in FIG. 1 is provided, and the nonlinear-resistance resin material 1 yet to be formed is obtained.

The pressure forming step is a step of forming the nonlinear-resistance resin material 1, including the first particles 2 covered with the first resin phase 3, into a predetermined shape. The forming method is not particularly limited, and may be appropriately selected from among known forming methods according to the shape of the nonlinear-resistance resin material 1 to be produced. For example, after filling a mold with the nonlinear-resistance resin material 1 including the first particles 2 covered with the first resin phase 3, forming pressure may be applied to the nonlinear-resistance resin material 1 by a pressing machine to form the nonlinear-resistance resin material 1 into a predetermined shape. In addition, gas pressure may be increased to apply forming pressure to the nonlinear-resistance resin material 1 so as to form the nonlinear-resistance resin material 1 into a predetermined shape. In the present embodiment, a mold has been filled with the nonlinear-resistance resin material 1 and then, forming pressure has been applied to the nonlinear-resistance resin material 1 to form the nonlinear-resistance resin material 1 into a predetermined shape.

The curing step is a step of heating and curing the nonlinear-resistance resin material 1 formed into the predetermined shape. As a result of the heating and curing of the nonlinear-resistance resin material 1, adjacent first particles 2 are bound and electrically connected to each other via the first resin phase 3 as illustrated in FIG. 2. The method for curing the nonlinear-resistance resin material 1 is not particularly limited, and may be appropriately selected from among known curing methods. As a result of performing the above steps, the nonlinear-resistance resin material 1 is manufactured.

Next, effects of the nonlinear-resistance resin material 1 according to the present embodiment will be described.

In the present embodiment, the nonlinear-resistance resin material 1 includes: a plurality of the first particles 2 having nonlinear resistance characteristics such that the first particles 2 exhibit insulation properties when a voltage lower than a threshold value is applied and exhibit conductivity when a voltage equal to or higher than the threshold value is applied; and the first resin phase 3 containing the second particles 32 that are semiconducting or conducting, and covering at least partially surfaces of some or all of the plurality of first particles 2, as illustrated in FIG. 1. Furthermore, in the present embodiment, the first particles 2 adjacent to each other are bound and electrically connected to each other via the first resin phase 3, as illustrated in FIG. 2. In this way, the first resin phase 3, which is semiconducting or conducting, are suppressed from being joined together, so that electricity is less likely to be conducted in a thickness direction. As a result, it is possible to suppress a resistance value from falling below a resistance value of designed nonlinear resistance characteristics, so as to prevent a decrease in the function of the nonlinear-resistance resin material 1 as an insulator under conditions where the nonlinear-resistance resin material 1 should function as an insulator.

In the present embodiment, the first resin phase 3 contains the second particles 32 which are semiconducting or conducting, as illustrated in FIG. 4. Furthermore, in the present embodiment, the volume percent of the first particles 2 in the nonlinear-resistance resin material 1 is 25 vol % or more and 74 vol % or less, and the volume percent of the second particles 32 in the first resin phase 3 is 1 vol % or more and 40 vol % or less. In this way, the nonlinear resistance characteristics of the nonlinear-resistance resin material 1 can be sufficiently exerted.

In the present embodiment, the volume percent of the second particles 32 in the nonlinear-resistance resin material 1 is 0.2 vol % or more and 2 vol % or less, and the volume of the voids 4 in the nonlinear-resistance resin material 1 is larger than the volume of the first resin phase 3 in the nonlinear-resistance resin material 1. In this way, the nonlinear resistance characteristics of the nonlinear-resistance resin material 1 can be sufficiently exerted.

In the present embodiment, the average diameter of the second particles 32 is 1/10 or less of the average diameter of the first particles 2. Therefore, the surfaces of the first particles 2 are easily covered with the second particles 32.

In the present embodiment, the first particles 2 contain 80 wt % or more zinc oxide or silicon carbide. As a result, the nonlinear resistance characteristics of the first particles 2 can be sufficiently ensured.

In the present embodiment, since each first particle 2 is an aggregate of two or more primary particles, the degree of freedom of pressure increases during a crushing process at the time of production. Thus, productivity of the first particles 2 can be improved.

In the present embodiment, since the average diameter of the primary particles constituting the main component of the first particles 2 is less than 20 μm, adhesion between the first particles 2 and the first resin phase 3 can be enhanced.

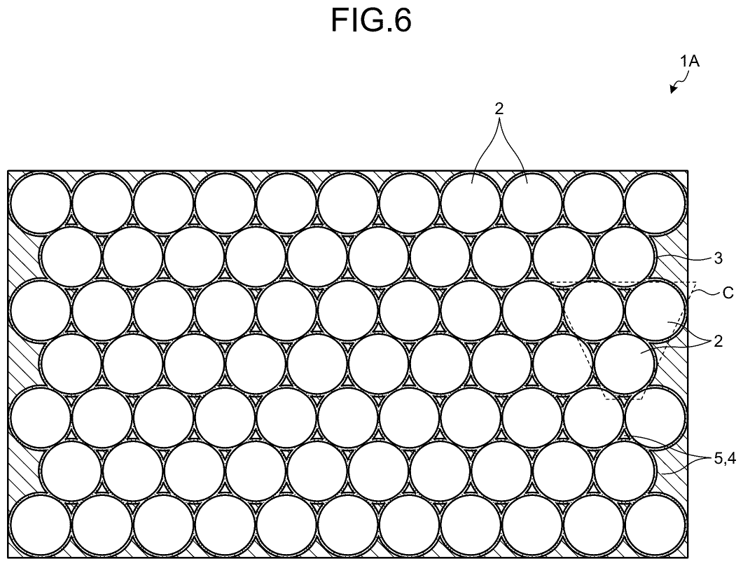

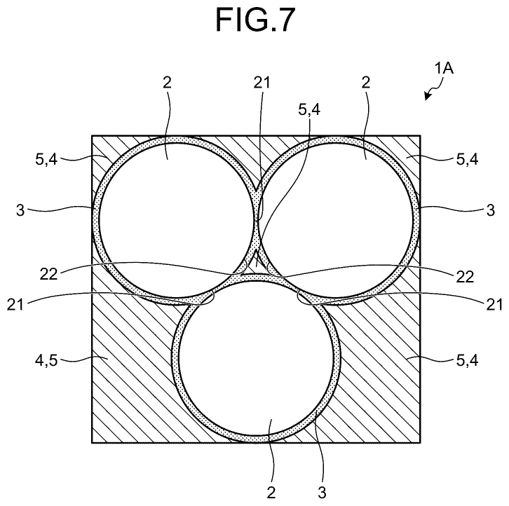

Next, a nonlinear-resistance resin material 1A according to a first modification of the first embodiment will be described with reference to FIGS. 6 and 7. FIG. 6 is a diagram schematically illustrating the nonlinear-resistance resin material 1A according to the first modification of the first embodiment. FIG. 7 is an enlarged view of a portion C illustrated in FIG. 6. The nonlinear-resistance resin material 1A according to the first modification is different from the above-described nonlinear-resistance resin material 1 according to the first embodiment in that the nonlinear-resistance resin material 1A includes a second resin phase 5. In the first modification, portions overlapping with the above-described nonlinear-resistance resin material 1 of the first embodiment are denoted by the same reference numerals, and description thereof is omitted. Note that FIGS. 6 and 7 illustrate a state in which portions referred to as the voids 4 in FIGS. 1 and 2 are filled with the second resin phase 5. In FIGS. 6 and 7, reference numerals 4 and 5 are used together for convenience of description.

The second resin phase 5 fills the voids 4 where none of the first particles 2 and the first resin phase 3 exists in the nonlinear-resistance resin material 1A. In addition, the second resin phase 5 has insulation properties. The volume percent of the second resin phase 5 in the nonlinear-resistance resin material 1A is preferably larger than the volume percent of the first resin phase 3 in the nonlinear-resistance resin material 1A.

The second resin phase 5 and the first resin phase 3 just need to be immiscible. For example, epoxy, polycarbonate, polypropylene, acrylic, phenol, polyvinyl chloride, polystyrene, unsaturated polyester, polyimide, and an acrylonitrile-butadiene-styrene copolymer are used as the second resin phase 5. Each of these resins may be used alone, or two or more of these resins may be used in combination. Furthermore, varnish derived from these resins dissolved in a solvent may be used as the second resin phase 5. For example, when polyvinyl alcohol is used as the first resin phase 3, it is preferable to use epoxy resin as the second resin phase 5 from the viewpoint of handleability. Thus, epoxy resin has been used also in the present modification. In the present modification, “CY230” manufactured by Nagase ChemteX Corporation has been used as a main agent of epoxy resin. In the present modification, “HY951” manufactured by Nagase ChemteX Corporation has been used as a curing agent for epoxy resin. Experiments and studies of the present discloser have confirmed that there is no difference in current-voltage characteristics between the nonlinear-resistance resin material 1A including the second resin phase 5 and the nonlinear-resistance resin material 1 not including the second resin phase 5. It is presumed that this is because there is no change in energizing paths between the nonlinear-resistance resin material 1A including the second resin phase 5 and the nonlinear-resistance resin material 1 not including the second resin phase 5.

When the nonlinear-resistance resin material 1A including the second resin phase 5 is produced, a combination step is performed after the curing step described above. The combination step is a step of combining the formed nonlinear-resistance resin material 1A with the second resin phase 5 having insulation properties. That is, after the curing step, the nonlinear-resistance resin material 1A is impregnated with the second resin phase 5 in a liquid state, to fill the voids 4 with the second resin phase 5. In the combination step, it is possible to impregnate the nonlinear-resistance resin material 1A with the second resin phase 5 up to finer voids 4 by performing the combination step under vacuum. After the combination step, a curing step of heating and curing the nonlinear-resistance resin material 1A containing the second resin phase 5 is newly performed.

In the present modification, the nonlinear-resistance resin material 1A includes the second resin phase 5. The second resin phase 5 has insulation properties, and fills the voids 4 where none of the first particles 2 and the first resin phase 3 exists. As a result, a structure having higher mechanical strength can be produced. In addition, it is possible to suppress occurrence of internal discharge when a high electric field is applied.

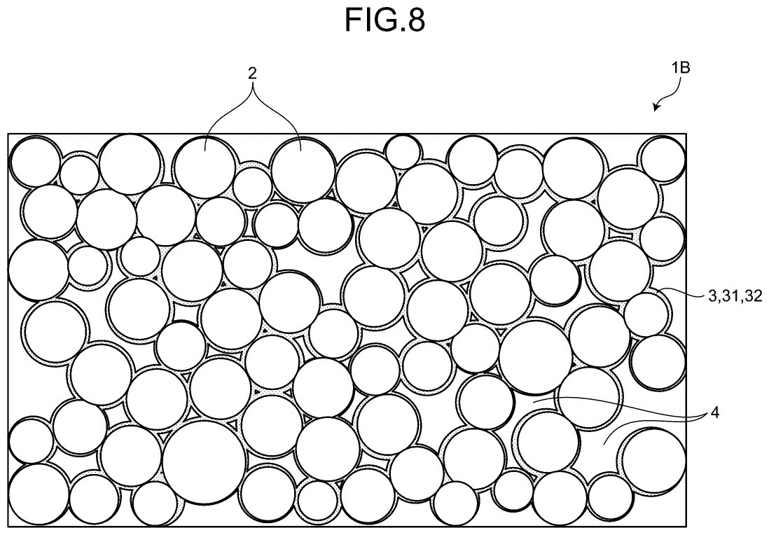

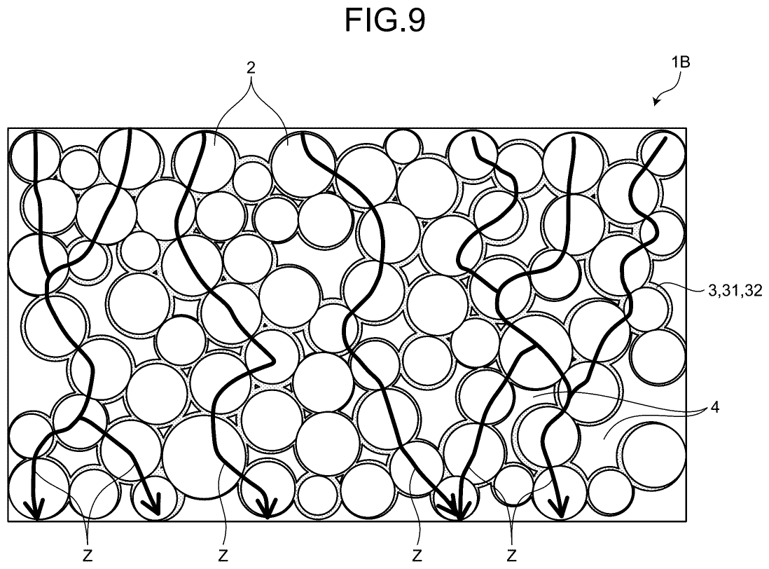

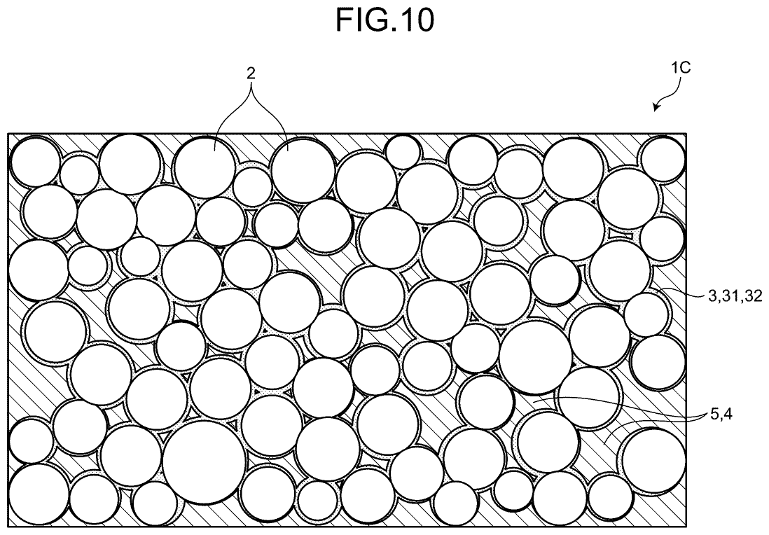

Next, a nonlinear-resistance resin material 1B according to a second modification of the first embodiment will be described with reference to FIGS. 8 and 9. FIG. 8 is a diagram schematically illustrating the nonlinear-resistance resin material 1B according to the second modification of the first embodiment. FIG. 9 is a diagram illustrating energizing paths Z of the nonlinear-resistance resin material 1B according to the second modification of the first embodiment. In the second modification, portions overlapping with the above-described nonlinear-resistance resin material 1 of the first embodiment are denoted by the same reference numerals, and description thereof is omitted.

The nonlinear-resistance resin material 1B includes a plurality of the first particles 2 with different diameters. The average diameter of the first particles 2 is not particularly limited, but is 50 μm in the present embodiment. The raw materials described above in the first embodiment are sprayed to spray-dry the raw materials. Thus, the first particles 2 are produced. The particle size distribution of the first particles 2 can be changed according to a spray amount when the raw materials are sprayed. The smaller the spray amount and the smaller a droplet size, the smaller the diameters of the first particles 2. As illustrated in FIG. 9, adjacent first particles 2 are bound to each other via the first resin phase 3, so that the energizing paths Z are formed which electrically connect the first particles 2 to each other. The present modification can also achieve the same effects as those of the first embodiment described above.

FIG. 10 is a diagram schematically illustrating a nonlinear-resistance resin material 1C according to a third modification of the first embodiment. As illustrated in FIG. 10, the nonlinear-resistance resin material 1C is different from the above-described nonlinear-resistance resin material 1B according to the second modification of the first embodiment in that the nonlinear-resistance resin material 1C includes the second resin phase 5. The nonlinear-resistance resin material 1C may include the second resin phase 5 which has insulation properties, and fills the voids 4 where none of the first particles 2 and the first resin phase 3 exists.

### Second Embodiment

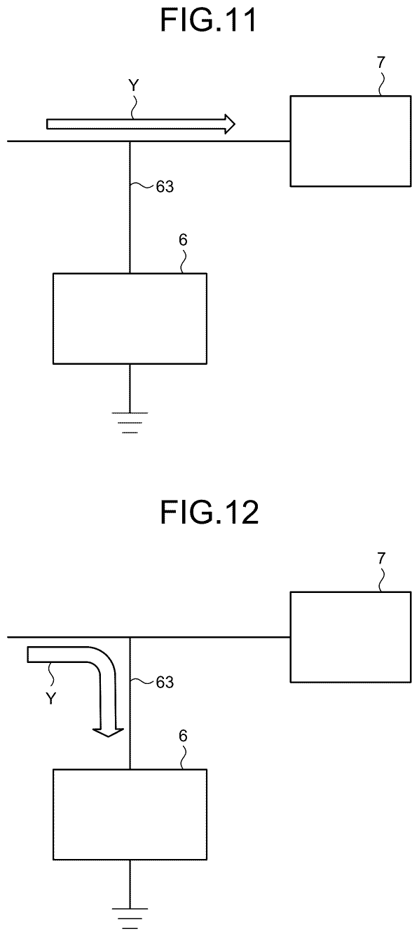

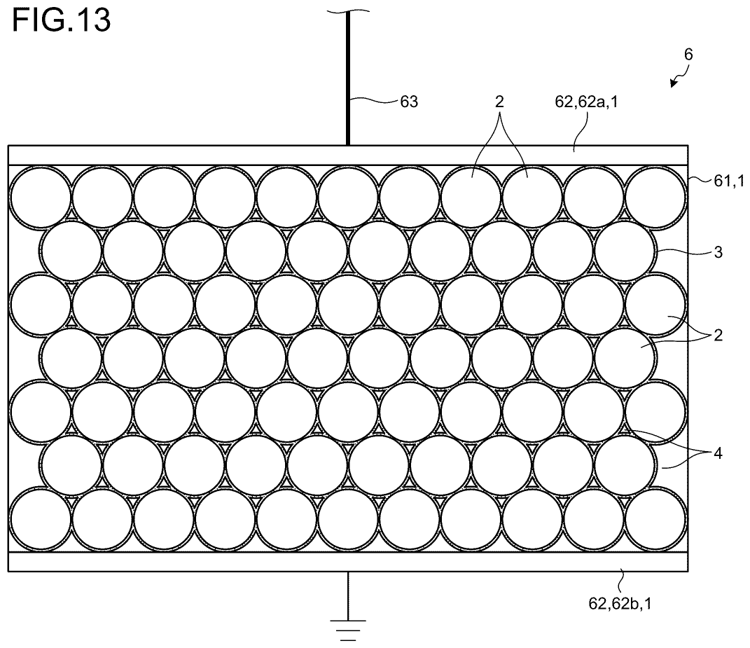

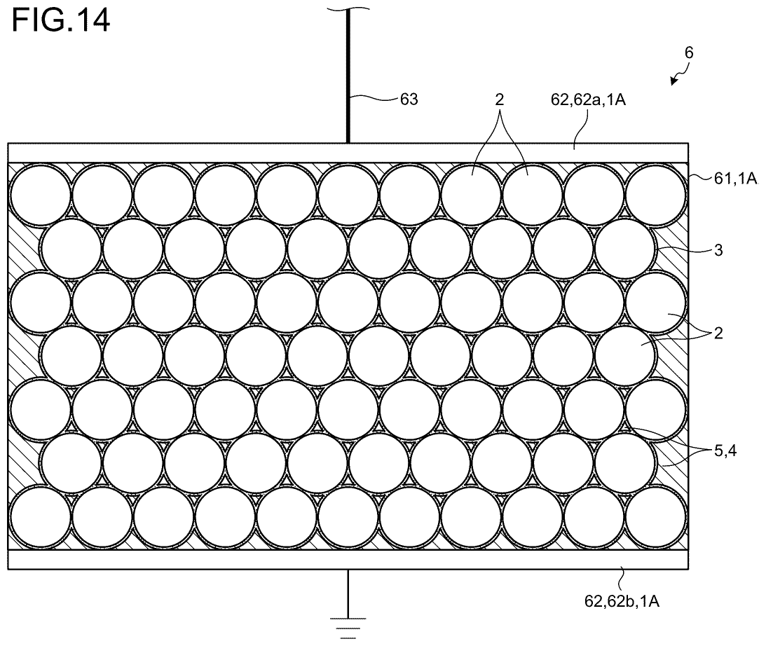

Next, an overvoltage protector 6 according to a second embodiment will be described with reference to FIGS. 11 to 13. FIG. 11 is a diagram schematically illustrating an example of connection between the overvoltage protector 6 according to the second embodiment and a to-be-protected device 7, and is a diagram illustrating a case where a voltage less than a threshold value is applied. FIG. 12 is a diagram schematically illustrating an example of connection between the overvoltage protector 6 according to the second embodiment and the to-be-protected device 7, and is a diagram illustrating a case where a voltage equal to or higher than the threshold value is applied. FIG. 13 is a diagram schematically illustrating a nonlinear resistor 61 of the overvoltage protector 6 according to the second embodiment, and is a diagram illustrating the nonlinear resistor 61 using the nonlinear-resistance resin material 1 according to the first embodiment. In the second embodiment, the same reference numerals are given to portions overlapping with the above-described first embodiment, and description thereof is omitted. Note that an arrow Y illustrated in FIGS. 11 and 12 indicates a flow of electricity.

The overvoltage protector 6 illustrated in FIGS. 11 and 12 is an apparatus that prevents an overvoltage from being applied to the to-be-protected device 7. As illustrated in FIGS. 11 to 13, the overvoltage protector 6 includes the nonlinear resistor 61 and a wiring 63 electrically connected to the to-be-protected device 7. The nonlinear resistor 61 illustrated in FIG. 13 includes the above-described nonlinear-resistance resin material 1 according to the first embodiment, and a plurality of electrodes 62 attached to the nonlinear-resistance resin material 1.

The shape of the nonlinear-resistance resin material 1 is not particularly limited, but is a cylindrical shape in the present embodiment. The number of the electrodes 62 is not particularly limited, but is two in the present embodiment. The electrodes 62 are attached along both ends in a short side direction of the nonlinear-resistance resin material 1. The shape of the electrode 62 is not particularly limited, but is circular in the present embodiment. When the two electrodes 62 are distinguished, one of the electrodes 62 is referred to as an electrode 62a, and the other electrode 62 is referred to as an electrode 62b. The electrode 62a is connected to the wiring 63, and the electrode 62b is grounded. For example, a silver paste that can be cured at room temperature is used as the electrode 62. Alternatively, an aluminum thermal spraying material is used as the electrode 62 as long as the aluminum thermal spraying material has sufficient heat resistance. The nonlinear resistor 61 is incorporated in the overvoltage protector 6 illustrated in FIGS. 11 and 12.

The overvoltage protector 6 and the to-be-protected device 7 are electrically connected in parallel. Assume that a voltage is applied to the one of the electrodes, that is, the electrode 62a illustrated in FIG. 13, the other electrode, that is, the electrode 62b illustrated in FIG. 13 is grounded, and an overvoltage may be applied to the electrode 62a to which the voltage is applied. In such a case, the nonlinear-resistance resin material 1 of the nonlinear resistor 61 serves as an insulator when a voltage lower than the threshold value is applied, as illustrated in FIG. 11. Meanwhile, the nonlinear-resistance resin material 1 of the nonlinear resistor 61 serves as a conductor when a voltage equal to or higher than the threshold value is applied, as illustrated in FIG. 12. Thus, a voltage between terminals can be lowered to protect the to-be-protected device 7.

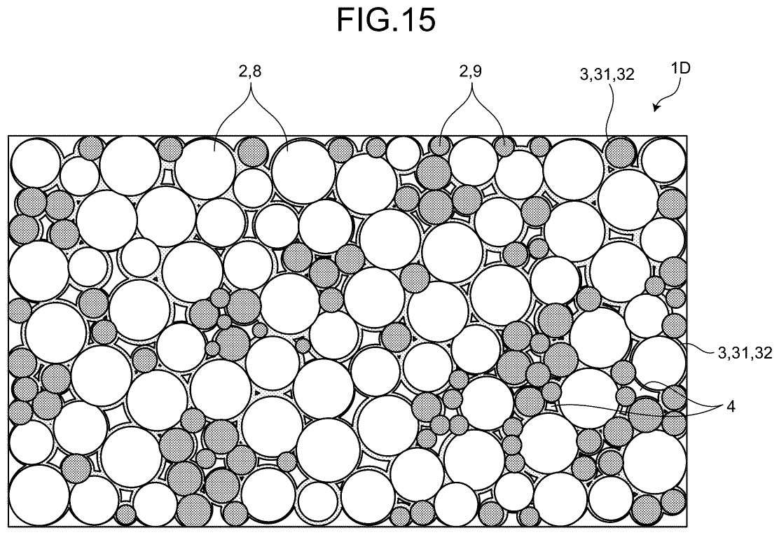

FIG. 14 is a diagram schematically illustrating the nonlinear resistor 61 of the overvoltage protector 6 according to the second embodiment, and is a diagram illustrating the nonlinear resistor 61 using the nonlinear-resistance resin material 1A according to the first modification of the first embodiment. The nonlinear resistor 61 includes the above-described nonlinear-resistance resin material 1A according to the modification of the first embodiment, and a plurality of the electrodes 62 attached to the nonlinear-resistance resin material 1A. Even when the nonlinear-resistance resin material 1A includes the second resin phase 5, the same effects as those of the present embodiment can be achieved. That is, the nonlinear-resistance resin material 1 according to the first embodiment, the nonlinear-resistance resin material 1A according to the first modification of the first embodiment, the nonlinear-resistance resin material 1B according to the second modification of the first embodiment, or the nonlinear-resistance resin material 1C according to the third modification of the first embodiment can be used as the nonlinear resistor 61 to which an electric field is applied in such a way as to provide a potential difference between the electrodes 62a and 62b by, for example, applying a voltage to the one of the electrodes, that is, the electrode 62a and grounding the other electrode, that is, the electrode 62b.

### Third Embodiment

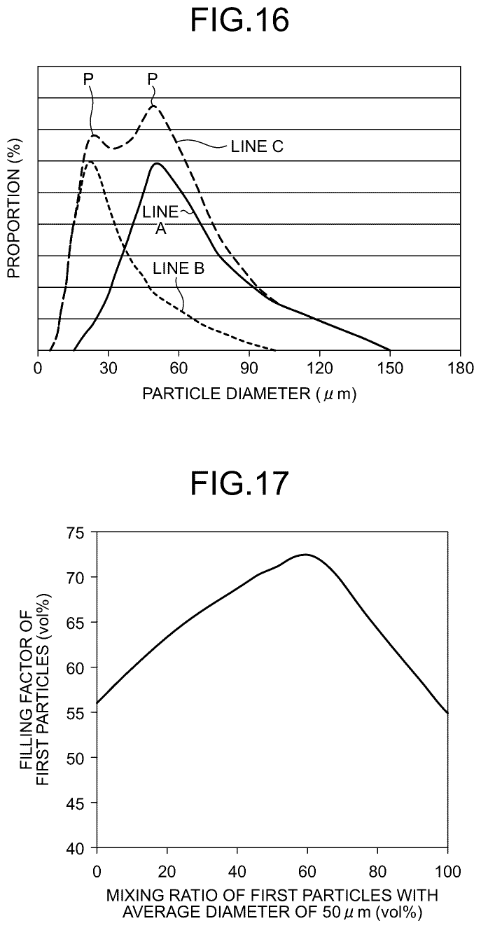

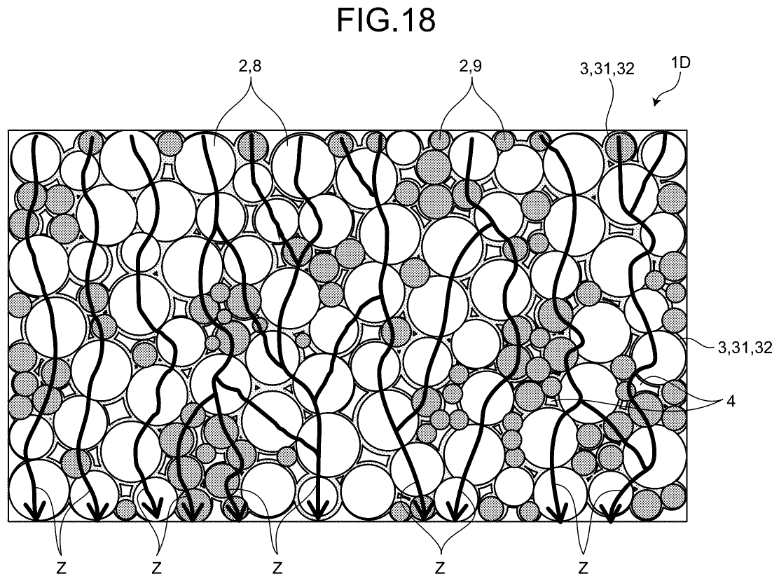

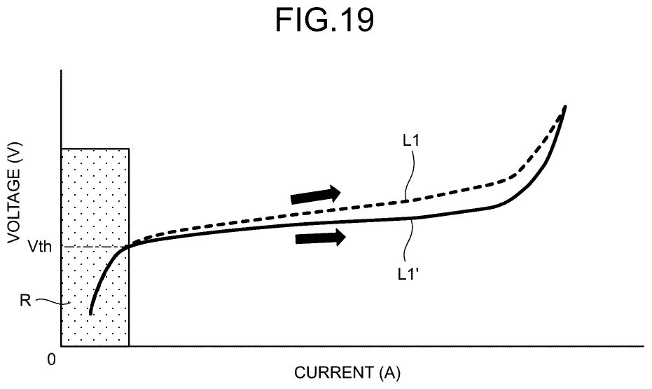

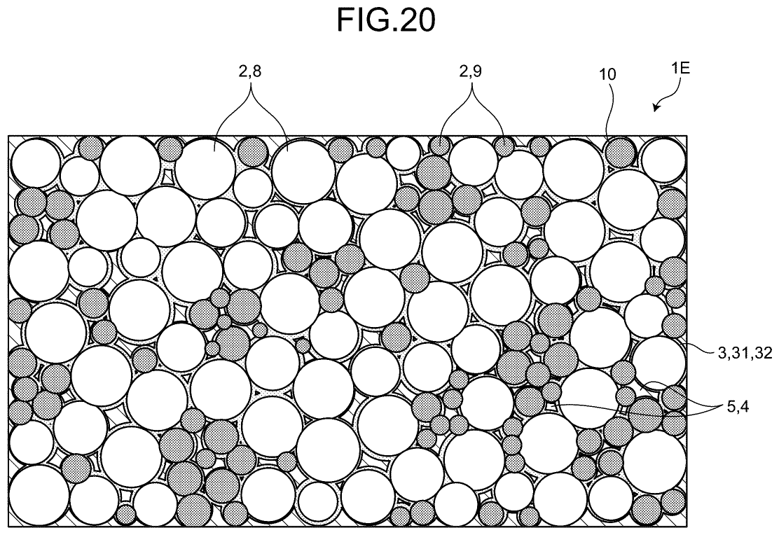

Next, a nonlinear-resistance resin material 1D according to a third embodiment will be described with reference to FIGS. 15 to 19. FIG. 15 is a diagram schematically illustrating the nonlinear-resistance resin material 1D according to the third embodiment. FIG. 16 is a diagram illustrating particle size distributions of the first particles 2 of the nonlinear-resistance resin material 1D according to the third embodiment. FIG. 17 is a diagram illustrating the relationship between the mixing ratio and filling factor of the first particles 2 in the nonlinear-resistance resin material 1D according to the third embodiment. FIG. 18 is a diagram illustrating the energizing paths Z of the nonlinear-resistance resin material 1D according to the third embodiment. FIG. 19 is a diagram illustrating current-voltage characteristics of the first particles 2 of the nonlinear-resistance resin material 1D according to the third embodiment and current-voltage characteristics of the first particles 2 of the nonlinear-resistance resin material 1 according to the first embodiment. The nonlinear-resistance resin material 1D according to the third embodiment is different from the above-described nonlinear-resistance resin material 1B according to the second modification of the first embodiment in that the nonlinear-resistance resin material 1D includes the first particles 2 of two types having different particle size distributions. In the third embodiment, portions overlapping with the above-described nonlinear-resistance resin material 1B according to the second modification of the first embodiment are denoted by the same reference numerals, and description thereof is omitted.

The nonlinear-resistance resin material 1D illustrated in FIG. 15 includes the first particles 2 of two or more types with different particle size distributions. The nonlinear-resistance resin material 1D includes the first particles 2 of two or more types with different average diameters. In the present embodiment, a case is described as an example in which the first particles 2 with an average diameter of 50 μm and the first particles 2 with an average diameter of 20 μm are mixed, and the particle size distribution of the first particles 2 with an average diameter of 50 μm is different from the particle size distribution of the first particles 2 with an average diameter of 20 μm. Hereinafter, the first particles 2 with an average diameter of 50 μm may be referred to as large particles 8, and the first particles 2 with an average diameter of 20 μm may be referred to as small particles 9. In FIG. 15, in order to distinguish the large particle 8 from the small particle 9, each large particle 8 is represented as an open circle, and each small particle 9 is shaded. The small particles 9 enter the voids 4 between the large particles 8. The small particles 9 are disposed in such a way as to fill the voids 4 between the large particles 8. Note that the average diameter of the first particles 2 is not limited to the numerical values cited as examples.

A line A in FIG. 16 indicates the particle size distribution of the first particles 2 with an average diameter of 50 μm. A line B in FIG. 16 indicates the particle size distribution of the first particles 2 with an average diameter of 20 μm. A line C in FIG. 16 indicates the particle size distribution of all the first particles 2. In FIG. 16, the horizontal axis represents the diameter (μm) of the first particles 2, and the vertical axis represents the proportion (%) of the first particles 2 corresponding to each diameter. The particle size distribution of the first particles 2 with an average diameter of 50 μm is different from the particle size distribution of the first particles 2 with an average diameter of 20 μm. The particle size distribution of all the first particles 2 has two local maximum values P at which a proportion of presence of the first particles 2 is locally maximized. In other words, when the particle size distribution of all the first particles 2 is represented by a particle size distribution curve with predetermined particle diameter divisions on the horizontal axis and the proportion of the first particles 2 corresponding to each particle diameter division on the vertical axis, the particle size distribution curve has two local maximum values P.

FIG. 17 illustrates the relationship between the mixing ratio (vol %) of the first particles 2 with an average diameter of 50 μm and the filling factor (vol %) of the first particles 2. The horizontal axis in FIG. 17 represents the mixing ratio (vol %) of the first particles 2 with an average diameter of 50 μm, and the vertical axis in FIG. 17 represents the filling factor (vol %) of the first particles 2. The filling factor of the first particles 2 refers to the volume percent of the first particles 2 in the nonlinear-resistance resin material 1D. As is clear from FIG. 17, when the mixing ratio of the first particles 2 with an average diameter of 50 μm is 60 vol %, the filling factor of the first particles 2 is maximized. Note that when the mixing ratio of the first particles 2 with an average diameter of 50 μm is 60 vol %, the mixing ratio of the first particles 2 with an average diameter of 20 μm is 40 vol %.

Next, a description will be given of effects of the nonlinear-resistance resin material 1D according to the present embodiment.

When only the first particles 2 with an average diameter of 50 μm are used as in the second modification of the first embodiment illustrated in FIG. 8, that is, when the first particles 2 having a single type of particle size distribution are used, the voids 4 between the first particles 2 adjacent to each other become large. Meanwhile, when the nonlinear-resistance resin material 1D includes the first particles 2 of two types having different particle size distributions, and the particle size distribution of all the first particles 2 has the two local maximum values P at which the proportion of presence of the first particles 2 is locally maximized, as in the present embodiment illustrated in FIG. 15, the small particles 9 with a small diameter enter the voids 4 between the large particles 8 with a large diameter. Therefore, the voids 4 between the first particles 2 adjacent to each other are reduced or eliminated. As a result, the filling factor of the first particles 2 can be increased. In addition, since the small particles 9 with a small diameter enter spaces between the large particles 8 with a large diameter, it is possible to increase the area of binding between the first particles 2. This increases the number of the energizing paths Z that electrically connect the first particles 2 to each other, as illustrated in FIG. 18. That is, since electricity is conducted via binding portions of the first particles 2, it is possible to increase the number of the energizing paths Z that electrically connect the first particles 2 to each other by increasing the area of binding between the first particles 2. When the number of the energizing path Z increases, it is possible to cause a large amount of current to flow in a current region in which a voltage exceeding the threshold voltage Vₜₕ is applied.

A line L1′ in FIG. 19 indicates current-voltage characteristics of the first particles 2 of the nonlinear-resistance resin material 1D to be exhibited when the mixing ratio of the first particles 2 with an average diameter of 50 μm is 60 vol % and the mixing ratio of the first particles 2 with an average diameter of 20 μm is 40 vol %, that is, when the filling factor of the first particles 2 is maximized. A line L1 in FIG. 19 is the same as the line L1 illustrated in FIG. 5, and indicates the current-voltage characteristics of the first particles 2 of the nonlinear-resistance resin material 1 according to the first embodiment. As is clear from FIG. 19, the slope of the line L1′ is less than the slope of the line L1. In other words, in the present embodiment, the slope of the line L1 can be further reduced to obtain the line L1′. Therefore, in the present embodiment, it is possible to further increase a nonlinear resistance index of the nonlinear-resistance resin material 1D, as compared with the first embodiment described above, by further improving the nonlinear resistance characteristics of the nonlinear-resistance resin material 1D.

FIG. 20 is a diagram schematically illustrating a nonlinear-resistance resin material 1E according to a modification of the third embodiment. As illustrated in FIG. 20, the nonlinear-resistance resin material 1E may include the second resin phase 5 which has insulation properties, and fills the voids 4 where none of the first particles 2 and the first resin phase 3 exists.

The nonlinear-resistance resin material 1D includes the first particles 2 of two types having different particle size distributions in the present embodiment. Meanwhile, the nonlinear-resistance resin material 1D may include the first particles 2 of three or more types having different particle size distributions, as long as the filling factor of the first particles 2 can be increased. In other words, the nonlinear-resistance resin material 1D may include the first particles 2 of two or more types with different particle size distributions. Note that the particle size distribution of all the first particles 2 may have two or more local maximum values P at which the proportion of presence of the first particles 2 is locally maximized.

The first particles 2 with an average diameter of 50 μm may be covered with the first resin phase 3 containing the second particles 32, and the first particles 2 with an average diameter of 20 μm may be not covered with the first resin phase 3. Experiments and studies of the present discloser have confirmed that the current-voltage characteristics of the first particles 2 are improved even in this case such that current-voltage characteristics improve from the current-voltage characteristics indicated by the line L1 to the line L1′ illustrated in FIG. 19. Note that when binding between the first particles 2 is insufficient, the first particles 2 with an average diameter of 20 μm may be covered with a third resin phase 10 not containing the second particles 32, as illustrated in FIG. 20. The composition of the third resin phase 10 may be the same as the composition of the first resin phase 3 except that the third resin phase 10 does not contain the second particles 32. Meanwhile, the first particles 2 with an average diameter of 50 μm may be not covered with the first resin phase 3, and the first particles 2 with an average diameter of 20 μm may be covered with the first resin phase 3 containing the second particles 32. Experiments and studies of the present discloser have confirmed that the current-voltage characteristics of the first particles 2 are improved even in this case such that current-voltage characteristics change from the current-voltage characteristics indicated by the line L1 and approach the line L1′ illustrated in FIG. 19. Note that when binding between the first particles 2 is insufficient, the first particles 2 with an average diameter of 50 μm may be covered with the third resin phase 10 not containing the second particles 32. As described above, when the nonlinear-resistance resin material 1D includes the first particles 2 of two types with different average diameters, at least one type of first particle 2 may be covered with the first resin phase 3 containing the second particles 32, and at least one type of first particle 2 may be not covered with the first resin phase 3, or may be covered with the third resin phase 10 not containing the second particles 32. In this way, the amount of the first resin phase 3 containing the second particles 32 to be used can be reduced, and the amount of treatment of the first resin phase 3 containing the second particles 32 can be reduced. Thus, the productivity of the nonlinear-resistance resin material 1D can be improved. In addition, when at least one type of first particle 2 is not covered with the first resin phase 3, the at least one type of first particle 2, the first matrix resin 31 in a liquid state, and the second particles 32 are mixed to prepare the nonlinear-resistance resin material 1D yet to be formed, and then the nonlinear-resistance resin material 1D yet to be formed just needs to be mixed with the first particles 2 of the other type having a different average diameter, in the mixing step. Furthermore, when at least one type of first particle 2 is covered with the third resin phase 10, a step of mixing the at least one type of first particle 2, the first matrix resin 31 in a liquid state, and the second particles 32 to prepare the nonlinear-resistance resin material 1D yet to be formed just needs to be performed, in the mixing step, separately from a step of mixing the first particles 2 of the other type having a different average diameter with the matrix resin in a liquid state, which is to serve as the third resin phase 10, to prepare the nonlinear-resistance resin material 1D yet to be formed. Then, the separately prepared nonlinear-resistance resin materials 1D yet to be formed just need to be mixed.

When the nonlinear-resistance resin material 1D includes the first particles 2 of three or more types with different average diameters, at least one type of first particle 2 may be covered with the first resin phase 3 containing the second particles 32, and at least one type of first particle 2 may be not covered with the first resin phase 3, or may be covered with the third resin phase 10 not containing the second particles 32. Experiments and studies of the present discloser have confirmed that the current-voltage characteristics of the first particles 2 are improved even in this case such that current-voltage characteristics improve from the current-voltage characteristics indicated by the line L1 to the line L1′ illustrated in FIG. 19. In addition, the amount of the first resin phase 3 containing the second particles 32 to be used can be reduced, and the amount of treatment of the first resin phase 3 containing the second particles 32 can be reduced. Thus, the productivity of the nonlinear-resistance resin material 1D can be improved.

When the nonlinear-resistance resin material 1D includes the first particles 2 having a single type of average diameter, at least some of the first particles 2 may be covered with the first resin phase 3 containing the second particles 32, and at least some of the first particles 2 may be not covered with the first resin phase 3, or may be covered with the third resin phase 10 not containing the second particles 32. Experiments and studies of the present discloser have confirmed that the current-voltage characteristics of the first particles 2 are improved even in this case such that current-voltage characteristics improve from the current-voltage characteristics indicated by the line L1 to the line L1′ illustrated in FIG. 19. In addition, the amount of the first resin phase 3 containing the second particles 32 to be used can be reduced, and the amount of treatment of the first resin phase 3 containing the second particles 32 can be reduced. Thus, the productivity of the nonlinear-resistance resin material 1D can be improved.

Next, effects of the present disclosure will be further described with reference to examples and comparative examples.

### (Material Composition)

Nonlinear-resistance resin materials according to Examples 1 to 41, in which forming pressure was applied; and nonlinear-resistance resin materials according to Comparative Examples 1 to 8, in which forming pressure was not applied; were prepared according to blending quantities illustrated in Table 1. Polyvinyl alcohol resin (“GL-05” manufactured by Mitsubishi Chemical Corporation) was used as the first matrix resin constituting the first resin phase. Carbon powder (“CCE03PB” manufactured by Kojundo Chemical Laboratory Co., Ltd.) was used as the second particles constituting the first resin phase. Epoxy resin (main agent: “CY230” manufactured by Nagase ChemteX Corporation, curing agent: “HY951” manufactured by Nagase ChemteX Corporation) was used as the second resin phase. In Examples 1 to 41, a mold was filled with a nonlinear-resistance resin material yet to be formed, and a forming pressure of 300 kgf/cm² was applied to the nonlinear-resistance resin material to form the nonlinear-resistance resin material. When the nonlinear-resistance resin material is pressurized, first particles are bound and electrically connected to each other. In Comparative Examples 1 to 8 in which no forming pressure was applied to the nonlinear-resistance resin material, the first particles are not bound to each other, and are not electrically connected to each other. In the nonlinear-resistance resin materials according to Examples 1 to 41 and the nonlinear-resistance resin materials according to Comparative Examples 1 to 8, the following were changed: electrical connection between first particles having nonlinear resistance characteristics; pressurization; the volume percent of the first particles in the nonlinear-resistance resin material; the volume percent of the matrix resin of the first resin phase in the nonlinear-resistance resin material; the volume percent of second particles of the first resin phase in the nonlinear-resistance resin material; the volume percent of voids or the second resin phase in the nonlinear-resistance resin material; the volume percent of the second particles in the first resin phase; and the ratio of the average diameter of the second particles to the average diameter of the first particles.

TABLE 1

| | Electrical | | | | | | | | | | | | |
|---|---|---|---|---|---|---|---|---|---|---|---|---|---|
| | contact | | | | | | | | | Ratio of | | | |
| | between | | | | | | | | | average | | | |
| | first | | Volume percent in nonlinear resistance resin | | | | | | Volume | diameter of | | | |
| | particles | | material [symbol] | | | | | | percent | second | | | |
| | having | | | Matrix | | | | | of second | particles | | | |
| | nonlinear | | | | First resin | | | | particles | to average | Non- | | [symbol] |
| | resistance | | | | phase | | | Second | in first | diameter of | linear | | starting |
| | character- | Pressur- | First | | Matrix | Second | | resin | resin | first | resistive | | electric |
| | istics | ization | particles | | resin | particles | [symbol] | phase | phase | particles | index | Strength | field |
| Example 1 | Corrected | Pressurized | 74 | 26 | 8.3 | 0.41 | 17.3 | — | 4.8 | 1/10 or less | [symbol] | 3 | 3 |
| Example 2 | Corrected | Pressurized | 74 | 26 | 8.3 | 0.83 | 16.9 | — | 9.1 | 1/10 or less | [symbol] | 3 | 3 |
| Example 3 | Corrected | Pressurized | 74 | 26 | [symbol] | [symbol] | 15.9 | — | [symbol] | 1/10 or less | [symbol] | 3 | 3 |
| Example 4 | Corrected | Pressurized | 74 | 26 | [symbol] | [symbol] | 12.9 | — | [symbol] | 1/10 or less | [symbol] | 3 | 3 |
| Example 5 | Corrected | Pressurized | 74 | 26 | 8.3 | [symbol] | 7.5 | — | [symbol] | 1/10 or less | [symbol] | 3 | 3 |
| Example 6 | Corrected | Pressurized | 74 | 26 | 8.2 | 0.04 | 17.7 | — | 6.5 | 1/10 or less | [symbol] | 3 | 3 |
| Example 7 | Corrected | Pressurized | 25 | 75 | [symbol] | 0.24 | 72.1 | — | [symbol] | 1/10 or less | [symbol] | 3 | 3 |
| Example 8 | Corrected | Pressurized | 25 | 75 | [symbol] | 0.28 | [symbol] | — | 9.1 | 1/10 or less | [symbol] | 4 | 4 |
| Example 9 | Corrected | Pressurized | 25 | 75 | [symbol] | [symbol] | [symbol] | — | 16.7 | 1/10 or less | [symbol] | 4 | 4 |
| Example 10 | Corrected | Pressurized | 25 | 75 | [symbol] | [symbol] | 73.6 | — | 33.3 | 1/10 or less | [symbol] | 4 | 4 |
| Example 11 | Corrected | Pressurized | 25 | 75 | 3.1 | [symbol] | [symbol] | — | 36.0 | 1/10 or less | [symbol] | 4 | 4 |
| Example 12 | Corrected | Pressurized | 74 | 26 | 13.1 | [symbol] | 12.4 | — | 3.2 | 1/10 or less | 4 | 3 | 3 |
| Example 13 | Corrected | Pressurized | 74 | 26 | 13.2 | [symbol] | [symbol] | — | 6.3 | 1/10 or less | 4 | 3 | 3 |
| Example 14 | Corrected | Pressurized | 74 | 26 | 13.4 | 1.78 | 10.8 | — | 11.8 | 1/10 or less | 4 | 3 | 3 |
| Example 15 | Corrected | Pressurized | 74 | 26 | [symbol] | [symbol] | 7.5 | — | 26.0 | 1/10 or less | 4 | 3 | 3 |
| Example 16 | Corrected | Pressurized | 25 | 76 | 4.4 | [symbol] | [symbol] | — | 3.2 | 1/10 or less | 4 | 4 | 4 |
| Example 17 | Corrected | Pressurized | 25 | 75 | 4.5 | [symbol] | [symbol] | — | [symbol] | 1/10 or less | [symbol] | 4 | 4 |
| Example 18 | Corrected | Pressurized | 25 | 75 | [symbol] | [symbol] | [symbol] | — | [symbol] | 1/10 or less | [symbol] | 4 | 4 |
| Example 19 | Corrected | Pressurized | 25 | 75 | [symbol] | [symbol] | [symbol] | — | [symbol] | 1/10 or less | [symbol] | 4 | 4 |
| Example 20 | Corrected | Pressurized | 74 | 26 | [symbol] | [symbol] | [symbol] | — | [symbol] | 1/10 or less | [symbol] | 3 | 3 |
| Example 21 | Corrected | Pressurized | 74 | 26 | [symbol] | 0.94 | 8.3 | — | [symbol] | 1/10 or less | [symbol] | 3 | 3 |
| Example 22 | Corrected | Pressurized | 74 | 26 | [symbol] | [symbol] | [symbol] | — | 11.8 | 1/10 or less | [symbol] | 3 | 3 |
| Example 23 | Corrected | Pressurized | 74 | 26 | [symbol] | [symbol] | 1.3 | — | 26.0 | 1/10 or less | [symbol] | 3 | 3 |
| Example 24 | Corrected | Pressurized | 25 | 75 | 8.3 | 0.18 | 88.6 | — | 2.4 | 1/10 or less | 4 | 4 | 4 |
| Example 25 | Corrected | Pressurized | 25 | 75 | 8.3 | 0.32 | 88.4 | — | [symbol] | 1/10 or less | 3 | 4 | 4 |
| Example 26 | Corrected | Pressurized | 25 | 75 | 8.8 | [symbol] | [symbol] | — | [symbol] | 1/10 or less | 3 | 4 | 4 |
| Example 27 | Corrected | Pressurized | 25 | 75 | [symbol] | [symbol] | [symbol] | — | 20.0 | 1/10 or less | 3 | 4 | 4 |
| Example 28 | Corrected | Pressurized | 25 | 75 | [symbol] | 0.82 | 16.2 | — | [symbol] | 1/10 or less | 3 | 3 | 3 |
| Example 29 | Corrected | Pressurized | 25 | 75 | [symbol] | [symbol] | 12.2 | — | [symbol] | 1/10 or less | 3 | 3 | 3 |
| Example 30 | Corrected | Pressurized | 25 | 75 | 18.8 | [symbol] | 6.7 | — | 2.4 | 1/10 or less | 3 | 3 | 3 |
| Example 31 | Corrected | Pressurized | 25 | 75 | 8.4 | [symbol] | 16.2 | — | [symbol] | 1/10 or less | 3 | 3 | 3 |
| Example 32 | Corrected | Pressurized | 24 | 76 | [symbol] | 0.13 | 13.2 | — | [symbol] | 1/10 or less | 3 | 8 | 4 |
| Example 33 | Corrected | Pressurized | 24 | 76 | 4.3 | 0.28 | [symbol] | — | 3.2 | 1/10 or less | 3 | 8 | 4 |
| Example 34 | Corrected | Pressurized | 24 | 76 | 8.0 | [symbol] | [symbol] | — | 2.4 | 1/10 or less | 3 | 8 | 4 |
| Example 35 | Corrected | Pressurized | 24 | 76 | 2.7 | [symbol] | 73.2 | — | 4.8 | 1/10 or less | 3 | 8 | 4 |
| Example 36 | Corrected | Pressurized | 74 | 76 | 8.3 | 0.41 | 17.3 | — | 4.8 | More than 1/10 | 4 | [symbol] | 3 |
| Example 37 | Corrected | Pressurized | 25 | 75 | 2.8 | 0.18 | [symbol] | — | 4.8 | More than 1/10 | 8 | 8 | 4 |
| Example 38 | Corrected | Pressurized | 60 | 40 | 8.7 | [symbol] | [symbol] | — | 4.8 | 1/10 or less | 8 | [symbol] | 3 |
| Example 39 | Corrected | Pressurized | 33 | 67 | 4.2 | 0.21 | [symbol] | — | 4.8 | 1/10 or less | 8 | 8 | 3 |
| Example 40 | Corrected | Pressurized | 74 | 26 | 8.3 | [symbol] | — | [symbol] | 4.8 | 1/10 or less | 8 | 8 | 3 |
| Example 41 | Corrected | Pressurized | 25 | 75 | 2.8 | 0.14 | — | 12.1 | 4.8 | 1/10 or less | [symbol] | 8 | 3 |
| Comparative | Not | Not | 74 | 26 | 8.3 | [symbol] | 13.3 | — | 4.8 | 1/10 or less | 2 | 3 | 3 |
| Example 1 | corrected | pressurized | | | | | | | | | | | |
| Comparative | Not | Not | 25 | 75 | 2.8 | 0.18 | 12.1 | — | 4.8 | 1/10 or less | 1 | [symbol] | 4 |
| Example 2 | corrected | pressurized | | | | | | | | | | | |
| Comparative | Not | Not | 74 | 26 | 13.1 | [symbol] | 12.4 | — | 3.2 | 1/10 or less | 1 | 3 | 3 |
| Example 3 | corrected | pressurized | | | | | | | | | | | |
| Comparative | Not | Not | 25 | 75 | 4.4 | [symbol] | [symbol] | — | 3.2 | 1/10 or less | 2 | 4 | 4 |
| Example 4 | corrected | pressurized | | | | | | | | | | | |
| Comparative | Not | Not | 74 | 26 | 18.6 | [symbol] | 8.8 | — | 2.4 | 1/10 or less | 1 | 3 | 3 |
| Example 5 | corrected | pressurized | | | | | | | | | | | |
| Comparative | Not | Not | 25 | 75 | 6.3 | [symbol] | [symbol] | — | 2.8 | 1/10 or less | 2 | 4 | [symbol] |
| Example 6 | corrected | pressurized | | | | | | | | | | | |
| Comparative | Not | Not | 74 | 26 | 8.3 | 0.41 | — | — | 4.8 | 1/10 or less | 2 | [symbol] | [symbol] |
| Example 7 | corrected | pressurized | | | | | | | | | | | |
| Comparative | Not | Not | 25 | 75 | 2.8 | 0.14 | — | — | 4.8 | 1/10 or less | 1 | [symbol] | [symbol] |
| Example 8 | corrected | pressurized | | | | | | | | | | | |

[symbol]

indicates data missing or illegible when filed

### (Test Method)

For the nonlinear-resistance resin materials according to Examples 1 to 41 and Comparative Examples 1 to 8, nonlinear resistance characteristics, strength, and a discharge starting electric field were evaluated as a result of being measured by the following test methods. Each item was evaluated on a five-point scale. A larger number indicates better, a smaller number indicates worse, and three or more points indicate that an evaluation result is within an acceptable range. Nonlinear resistance characteristics are expressed by nonlinear resistance indices.

### [Nonlinear Resistance Index]

While a voltage was being applied to an obtained nonlinear-resistance resin material, a value of flowing current was measured to acquire current-voltage characteristics, and a nonlinear resistance index was calculated.

### [Strength]

The obtained nonlinear-resistance resin material was compressed, and compressive strength was measured.

### [Discharge Starting Electric Field]

A voltage was applied to the obtained nonlinear-resistance resin material, and a voltage value at which discharge occurred was measured.

As is clear from Table 1, in the nonlinear-resistance resin materials of Examples 1 to 41 in which forming pressure was applied to nonlinear-resistance resin materials, the first particles having nonlinear resistance characteristics were bound and electrically connected to each other. Therefore, the nonlinear resistance index of each of the nonlinear-resistance resin materials of Examples 1 to 41 was 3 or more, exhibiting nonlinear resistance characteristics. Meanwhile, in Comparative Examples 1 to 8 in which forming pressure was not applied to nonlinear-resistance resin materials, the first particles having nonlinear resistance characteristics were not bound to each other, and were not electrically connected to each other. Therefore, the nonlinear resistance index of each of the nonlinear-resistance resin materials of Comparative Examples 1 to 8 was 1 or 2, exhibiting no nonlinear resistance characteristics. From these results, it has been found that causing the first particles having nonlinear resistance characteristics to be bound and electrically connected to each other as a result of applying forming pressure to the nonlinear-resistance resin material is effective in improving nonlinear resistance characteristics.

The nonlinear resistance index was 4 or more in Examples 1, 2, 3, 4, 7, 8, 9, 10, 12, 13, 14, 15, 16, 17, 18, 19, 20, 21, 22, 23, 24, 25, 26, 27, 36, 38, 39, 40, and 41 in which the volume percent of the first particles in the nonlinear-resistance resin material was 25 vol % or more and 74 vol % or less and the volume percent of the second particles in the first resin phase was 1 vol % or more and 40 vol % or less. Meanwhile, the nonlinear resistance index was 3 in Examples 5, 6, 11, 28, 29, 30, 31, 32, 33, 34, and 35 in which the volume percent of the first particles in the nonlinear-resistance resin material was not 25 vol % or more and 74 vol % or less, or the volume percent of the second particles in the first resin phase was not 1 vol % or more and 40 vol % or less. From these results, it has been found that the following is effective in improving nonlinear resistance characteristics: the volume percent of the first particles in the nonlinear-resistance resin material is 25 vol % or more and 74 vol % or less, and the volume percent of the second particles in the first resin phase is 1 vol % or more and 40 vol % or less.

Among Examples in which the nonlinear resistance index was 4 or more, the nonlinear resistance index was 5 in Examples 1, 2, 3, 8, 9, 10, 17, 18, 19, 25, 26, 27, 38, 39, and 40 in which the volume percent of the second particles in the nonlinear-resistance resin material was 0.2 vol % or more and 2 vol % or less, and the volume of voids or the second resin phase was larger than the volume of the first resin phase. From these results, it has been found that the following is effective in improving nonlinear resistance characteristics: the volume percent of the second particles in the nonlinear-resistance resin material is 0.2 vol % or more and 2 vol % or less; and the volume of voids or the second resin phase is larger than the volume of the first resin phase.

Examples 1 and 36 differ in the ratio of the average diameter of the second particles to the average diameter of the first particles. Similarly, Examples 7 and 37 differ in the ratio of the average diameter of the second particles to the average diameter of the first particles. In Example 1 in which the average diameter of the second particles was 1/10 or less of the average diameter of the first particles, the nonlinear resistance index was 5. Meanwhile, in Example 36 in which the average diameter of the second particles was more than 1/10 of the average diameter of the first particles, the nonlinear resistance index was 4. Furthermore, in Example 7 in which the average diameter of the second particles was 1/10 or less of the average diameter of the first particles, the nonlinear resistance index was 4. Meanwhile, in Example 37 in which the average diameter of the second particles was more than 1/10 of the average diameter of the first particles, the nonlinear resistance index was 3. From these results, it has been found that the average diameter of the second particles is 1/10 or less of the average diameter of the first particles is effective in improving nonlinear resistance characteristics.

The difference between Examples 1 and 40 lies in whether voids are filled with the second resin phase. Similarly, the difference between Examples 7 and 41 lies in whether voids are filled with the second resin phase. In Example 1 in which the voids were not filled with the second resin phase, the strength and the discharge starting electric field were 3. Meanwhile, in Example 40 in which the voids were filled with the second resin phase, the strength and the discharge starting electric field were 5. Furthermore, in Example 7 in which the voids were not filled with the second resin phase, the strength and the discharge starting electric field were 4. Meanwhile, in Example 41 in which the voids were filled with the second resin phase, the strength and the discharge starting electric field were 5. From these results, it has been found that filling voids with the second resin phase is effective in improving strength and discharge characteristics.

The difference between Example 40 and Comparative Example 7 and the difference between Example 41 and Comparative Example 8 lie only in whether pressure was applied in a state where the second resin phase was provided. In each of Examples 40 and 41 and Comparative Examples 7 and 8, it is possible to maintain the strength and the discharge starting electric field at a high level by providing the second resin phase. Meanwhile, in Comparative Examples 7 and 8 in which forming pressure was not applied to the nonlinear-resistance resin material, the first particles were not bound to each other and were not electrically connected to each other, and thus the nonlinear resistance indices were smaller than those in Examples 40 and 41.

The configurations set forth in the above embodiments show examples, and it is possible to combine the configurations with another known technique or combine the embodiments with each other, and is also possible to partially omit or change the configurations without departing from the scope of the present disclosure.

### REFERENCE SIGNS LIST

1, 1A, 1B, 1C, 1D, 1E nonlinear-resistance resin material; 2 first particle; 3 first resin phase; 4 void; 5 second resin phase; 6 overvoltage protector; 7 to-be-protected device; 8 large particle; 9 small particle; 10 third resin phase; 21 contact portion; 22 noncontact portion; 31 first matrix resin; 32 second particle; 61 nonlinear resistor; 62, 62a, 62b electrode; 63 wiring.

1. A nonlinear-resistance resin material comprising:
a plurality of first particles having nonlinear resistance characteristics that:
exhibit insulation properties when a voltage lower than a threshold value is applied; and
exhibit conductivity when a voltage equal to or higher than the threshold value is applied;
a first resin phase that:
contains second particles that are semiconducting or conducting;
covers at least partially surfaces of some or all of the plurality of first particles; and
a second resin phase having insulation properties and filling voids where none of the first particles and the first resin phase exists, wherein
the first particles adjacent to each other are bound and electrically connected to each other via the first resin phase.

2. The nonlinear-resistance resin material according to claim 1, wherein
a volume percent of the first particles in the nonlinear-resistance resin material is 25 vol % or more and 74 vol % or less, and
a volume percent of the second particles in the first resin phase is 1 vol % or more and 40 vol % or less.

3. The nonlinear-resistance resin material according to claim 2, wherein
a volume percent of the second particles in the nonlinear-resistance resin material is 0.2 vol % or more and 2 vol % or less, and
a volume percent of the second resin phase in the nonlinear-resistance resin material is larger than a volume percent of the first resin phase in the nonlinear-resistance resin material.

4. The nonlinear-resistance resin material according to claim 3, wherein
an average diameter of the second particles is 1/10 or less of an average diameter of the first particles.

5. The nonlinear-resistance resin material according to claim 4, comprising:
the first particles of two or more types, the first particles of the two or more types being different in particle size distribution, wherein
a particle size distribution of all the first particles has two or more local maximum values at which a proportion of presence of the first particles is locally maximized.

6. The nonlinear-resistance resin material according to claim 5, comprising:
the first particles of two or more types with different average diameters, wherein
the first particles of at least one of the two or more types are covered with the first resin phase containing the second particles.

7. The nonlinear-resistance resin material according to claim 6, wherein
the first particles of at least one of the two or more types are covered with a third resin phase not containing the second particles.

8. The nonlinear-resistance resin material according to claim 1, wherein
the first particles contain 80 wt % or more zinc oxide or silicon carbide.

9. The nonlinear-resistance resin material according to claim 1, wherein
each of the first particles is an aggregate of two or more primary particles.

10. The nonlinear-resistance resin material according to claim 1, wherein
an average diameter of the primary particles constituting the first particles is less than 20 μm.

11. A nonlinear resistor comprising:
the nonlinear-resistance resin material according to claim 1; and
a plurality of electrodes attached to the nonlinear-resistance resin material.

12. An overvoltage protector configured to prevent an overvoltage from being applied to a to-be-protected device, the overvoltage protector comprising:
the nonlinear resistor according to claim 11; and
a wiring electrically connected to the to-be-protected device, wherein
at least one of the plurality of electrodes is grounded, and at least one of the plurality of electrodes is connected to the wiring.

13. A manufacturing method of a nonlinear-resistance resin material, the method comprising:
a mixing step of:
mixing a plurality of first particles having nonlinear resistance characteristics that exhibit insulation properties when a voltage lower than a threshold value is applied and exhibit conductivity when a voltage equal to or higher than the threshold value is applied with a first resin phase containing second particles that are semiconducting or conducting; and
covering at least partially surfaces of some or all of the plurality of first particles with the first resin phase,
a pressure forming step of forming a nonlinear-resistance resin material, including the first particles covered with the first resin phase, into a predetermined shape; and
a combination step of combining the formed nonlinear-resistance resin material with a second resin phase having insulation properties.
